(19) United States
(12) Patent Application Publication
(10) Pub. No.: US 2004/0203531 A1
(43) Pub. Date: Oct. 14, 2004

(54) Foldable type portable information terminal, answer holding method used in the same and program therefor

(75) Inventors: Masaki Shimamura, Tokyo (JP); Mika Fujii, Tokyo (JP); Mitio Nagai, Tokyo (JP); Kazuo Ootuta, Tokyo (JP); Kiyosi Kohayakawa, Tokyo (JP); Masatomo Mizuta, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/374,568

(22) Filed: Feb. 26, 2003

(30) Foreign Application Priority Data
Mar. 6, 2002 (JP) 059644/2002

(51) Int. Cl. H04B 1/38; H04M 1/00

(52) U.S. Cl. 455/90.3; 455/550.1

(57) ABSTRACT

A foldable type portable information terminal, an answer holding method and a program therefor can set and release answer holding with simple operation. The foldable type portable information terminal includes an upper unit having a display screen on one of upper and lower surfaces and a lower unit having an operation surface on one of upper and lower surfaces, and coupled with the upper unit for opening and closing and for pivoting. The terminal further includes a detector detecting change of relative attitude between the upper unit and the lower unit, and a controller setting answer holding state when the detector detects displacement of the upper unit to a preliminarily set first position upon call incoming.

### CROSS REFERENCE TO THE RELATED APPLICATION

The present application has been filed with claiming priority based on Japanese Patent Application No. 2002-059644, filed on Mar. 6, 2002. Disclosure of the above-identified Japanese Patent Application is herein incorporated by reference. The present invention is related to Japanese Patent Application No. 2002-059643, filed on Mar. 6, 2002 and U.S. patent application filed with claiming priority based Japanese Patent Application No. 2002-059643. Disclosure of the above-identified related application is herein incorporated by reference.

### BACKGROUND OF THE INVENTION

1. Field of the Invention

The present invention relates generally to a foldable type portable information terminal, an answer holding method used in the same and a program therefor. More particularly, the invention relates to a foldable type portable information terminal, in which an upper unit and a lower unit are coupled for opening and closing and for pivoting.

2. Description of the Related Art

Conventionally, among portable information terminals, particularly cellular telephone units, foldable type terminals or units have been widely preferred for capability of storage in compact and for capability of prevention of erroneous key operation on operating portions in comparison with straight type terminals or units to gain increasing demand.

On the other hand, in case of the cellular telephone units, terminals provided not only normal calling function but also browser function for browsing internet web page or the like, function as transmitting and receiving terminal of electronic mail, function of schedule management and so on. For the functions set forth above, enlarging of display is progressed for facilitating display of large amount of character information, graphic image and so on.

However, in case of the foregoing foldable type cellular telephone unit, shortcoming is encountered in vexatious complication in opening and closing the upper and lower units, constraint for vertically elongated display (constraint in number of display characters in lateral one line or in displaying laterally elongated image), constraint in design and so forth.

In order to solve these problem, there has been proposed a foldable type cellular telephone unit, in which the upper unit and the lower unit are coupled for providing capability not only for opening and closing of the upper unit and the lower unit and for pivoting relative to each other for convenience. For example, the foldable type cellular telephone unit of this kind is disclosed in Japanese Unexamined Patent Publication No. Heisei 11(1999)-30226, Japanese Unexamined Patent Publication No. Heisei 11(1999)-215218, and so forth.

However, in the foregoing foldable type portable information terminal, convenience is improved by providing capability not only for opening and closing of the upper unit and the lower unit but also for pivoting relative to each other, the upper and lower units are placed in various attitudes relative to each other. However, pivoting of the upper unit and the lower unit is simply used only for setting a display screen adapting to operation mode. An inconvenience is caused in that operation corresponding to the operation mode can be done only through the operation key.

For example, when the portable information terminal, such as the cellular telephone unit, is placed in a mode position where the upper unit and the lower unit are pivoted to place the display portion in laterally elongated attitude for accessing internet or other network on browser, checking or reading electronic mail message, playing game and so forth, if the operation mode transit to calling mode, it becomes necessary to pivot the upper and lower units for placing the display portion in longitudinally elongated normal attitude adapting to the calling mode for off-hooking or for answer holding operation through the operation key.

### SUMMARY OF THE INVENTION

The present invention has been worked out in order to solve the problem in the prior art set forth above. It is therefore an object of the present invention to provide a foldable type portable information terminal, an answer holding method and a program therefor or which can set and release answer holding with simple operation.

According to a first aspect of the present invention, a foldable type portable information terminal comprises:

an upper unit having a display screen on one of upper and lower surfaces;

a lower unit having an operation surface on one of upper and lower surfaces, and coupled with the upper unit for opening and closing and for pivoting;

detecting means for detecting change of relative attitude between the upper unit and the lower unit; and

control means for setting answer holding state when the detecting means detects displacement of the upper unit to a preliminarily set first position upon call incoming.

In the preferred construction, the control means releases answer holding state which is set previously, when the detecting means detects displacement of the upper unit to a preliminarily set second position.

The foldable type portable information terminal may further comprise interfacing means for connection with external equipment. In this case, the control means may set answer holding state when the detecting means detects displacement of the upper unit to the first position and further detects connection with the external equipment.

The control means may also perform control for outputting answer holding guidance depending upon displacement position of the upper unit when the detecting means detects displacement of one of a plurality of preliminarily set positions upon call incoming.

The control means may further set answer holding state when the upper unit is displaced to another preliminarily set position only when the upper unit is in a preliminarily set position,upon call incoming. Alternatively,the control means may set answer holding state when the upper unit is displaced to another preliminarily set position only when the upper unit is in a preliminarily set position and the portable information terminal is in a predetermined operation mode, upon call incoming.

According to the second aspect of the present invention, an answer holding method of a foldable type portable information terminal including an upper unit having a display screen on one of upper and lower surfaces, and a lower unit having an operation surface on one of upper and lower surfaces, and coupled with the upper unit for opening and closing and for pivoting, comprises:

detecting step of detecting change of relative attitude between the upper unit and the lower unit; and

control step of setting answer holding state when displacement of the upper unit to a preliminarily set first position is detected upon call incoming.

The method may further comprise step of releasing answer holding state which is set previously, when displacement of the upper unit to a preliminarily set second position is detected.

Preferably, the step of setting answer holding state may set answer holding state when displacement of the upper unit to the first position is detected and connection with the external equipment is detected.

The method may further comprise step of outputting answer holding guidance depending upon displacement position of the upper unit when displacement of one of a plurality of preliminarily set positions is detected upon call incoming.

The step of setting answer holding state may set answer holding state when the upper unit is displaced to another preliminarily set position only when the upper unit is in a preliminarily set position, upon call incoming. In the alternative, the step of answer holding state may set answer holding state when the upper unit is displaced to another preliminarily set position only when the upper unit is in a preliminarily set position and the portable information terminal is in a predetermined operation mode, upon call incoming.

According to the third aspect of the present invention, a program of an answer holding method of a foldable type portable information terminal including an upper unit having a display screen on one of upper and lower surfaces, and a lower unit having an operation surface on one of upper and lower surfaces, and coupled with the upper unit for opening and closing and for pivoting, comprises:

detecting step of detecting change of relative attitude between the upper unit and the lower unit; and

control step of setting answer holding state when displacement of the upper unit to a preliminarily set first position is detected upon call incoming.

Namely, the foldable type portable information terminal includes the upper unit and the lower unit coupled with each other for opening and closing and for pivoting. Upon call incoming, detecting opening and closing and/or pivoting of the upper unit and the lower unit, answer holding is set or released to improve operability.

Thus, the foldable type portable information terminal does not require particular key operation for setting and releasing answer holding. Therefore, while the terminal is used in the operation mode other than calling mode or upon reception of unexpected call, answer holding can be set and/or released by simply operation for improving convenience.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing a general construction of one embodiment of a portable information terminal according to the present invention;

FIG. 2 is a block diagram showing a detailed construction of one embodiment of a portable information terminal according to the present invention;

FIG. 3 is an external view of a cellular telephone unit applicable as one embodiment of a portable information terminal according to the present invention;

FIGS. 4A to 4D are illustration showing various attitude position of the cellular telephone unit shown in FIG. 3:

FIG. 5 is a flowchart showing example of operation of a control portion of FIG. 1;

FIG. 6 is a flowchart showing example of another operation of the control portion of FIG. 1; and

FIG. 7 is a flowchart showing example of another operation of the control portion of FIG. 1.

### DESCRIPTION OF THE PREFERRED EMBODIMENT

The present invention will be discussed hereinafter in detail in terms of the preferred embodiment of a foldable type portable information terminal, an answer holding method and a program therefor, in accordance with the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to avoid unnecessary obscurity of the present invention.

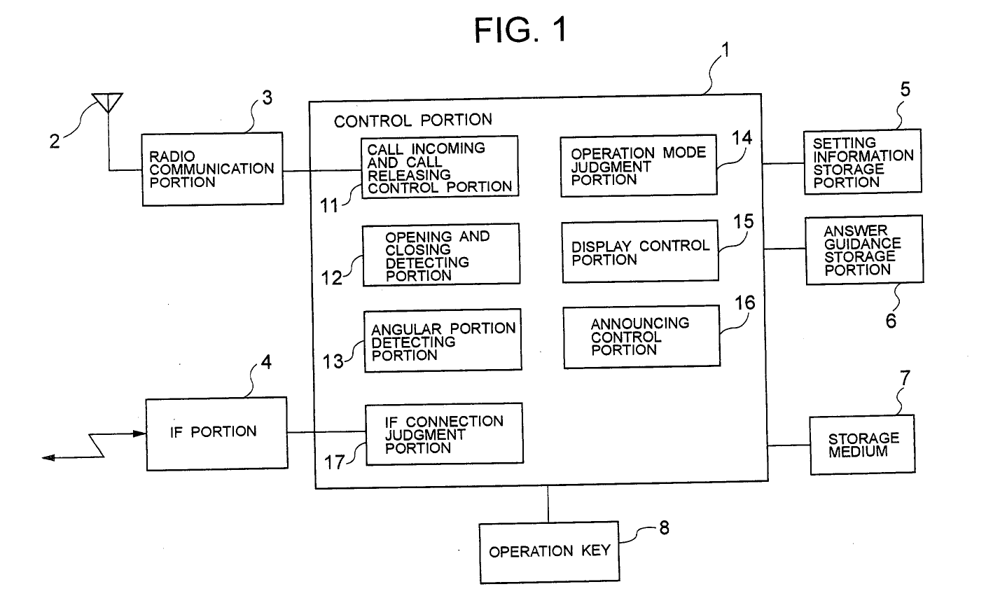

FIG. 1 is a block diagram showing a general construction of one embodiment of a portable information terminal according to the present invention. In FIG. 1, one embodiment of a foldable type portable information terminal is constructed with a control portion 1, an antenna 2, a radio communication portion 3, an IF (interface) portion 4, a setting information storage portion 5, a answer guidance storage portion 6, a storage medium 7 and an operation keys 8. These components are housed in upper unit and lower unit (not shown in FIG. 1), which are coupled for opening and closing and for pivoting.

The control portion 1 is constructed with a call incoming and call releasing control portion 11, an opening and closing detecting portion 12, an angular position detecting portion 13, an operation mode judgment portion 14, a display control portion 15, an announcement control portion 16 and an IF connection judgment portion 17. On the other hand, the control portion 1 is mainly constructed with a computer, and respective components illustrated in a form of functional blocks in FIG. 1 are realized by the computer executing a program stored in the storage medium 7.

It should be noted that detail of the announcement control portion and operation thereof has been disclosed in the above-identified commonly owned co-pending U. S. Patent Application, for “FOLDABLE TYPE PORTABLE INFORMATION TERMINAL, CONDITION NOTIFYING METHOD USED IN THE SAME AND PROGRAM THEREFOR”, filed with claiming priority based on Japanese Patent Application No. 2002-059643, filed on Mar. 6, 2002. Disclosure is herein incorporated by reference.

The call incoming and call releasing control portion 11 is adapted to perform call incoming control operation corresponding to opening and closing operation and pivoting operation of the upper unit. The opening and closing detecting portion 12 detects opening and closing condition and discriminates normal state (surface)and reversed state (back) of the upper unit. The angular position detecting portion 13 determines an angular position of the upper unit relative to the lower unit on the basis of outputs of various sensors (not shown in FIG. 1).

The operation mode judgment portion 14 makes judgment of operation mode (calling, playing game, contents reproduction and so forth) of own terminal. The display control portion 15 controls a display content and orientation of display content reflecting outputs of the angular position detecting portion 13 and opening and closing detecting portion 12. The IF connection judgment portion 17 determines connecting condition of the external equipment (not shown) to the IF portion 4.

The IF portion 4 is interface means for establishing connection in wire or radio. The setting information storage portion 5 stores various setting information relating to setting and releasing of answer holding depending upon relative position of the lower unit and the upper unit and so forth. The answer guidance storage portion 6 stores a guidance message information output upon setting answer holding state.

The storage medium 7 stores the program to be executed by the control portion 1. The operation keys 8 forming the operating portion are consisted of a transmission key, character/figure conversion key, power source ON/OFF key, a crisscross key for operating cursor, an end key and so forth.

The control portion 1 sets or release answer holding state in response to change of relative position (relative attitude of the lower unit and the upper unit as detected by the opening and closing detecting portion 12 or the angular position detecting portion 13 through magnetic sensors and magnets.

On the other hand, when a plurality of answer guidance message is stored in the answer message storage portion 6, the control portion 1 selectively generates one of the answer guidance messages stored in the answer guidance storage portion 6 depending upon result of detection by the opening and closing detecting portion 12 or the angular position detecting portion 13.

Also, when the portable information terminal used in operation mode other than calling mode immediately before call arrival is detected by the operation mode judgment portion 14 or connection of the external equipment via the IF portion 4 is detected, the control portion 1 additionally operates for placing the portable information terminal in answer holding state.

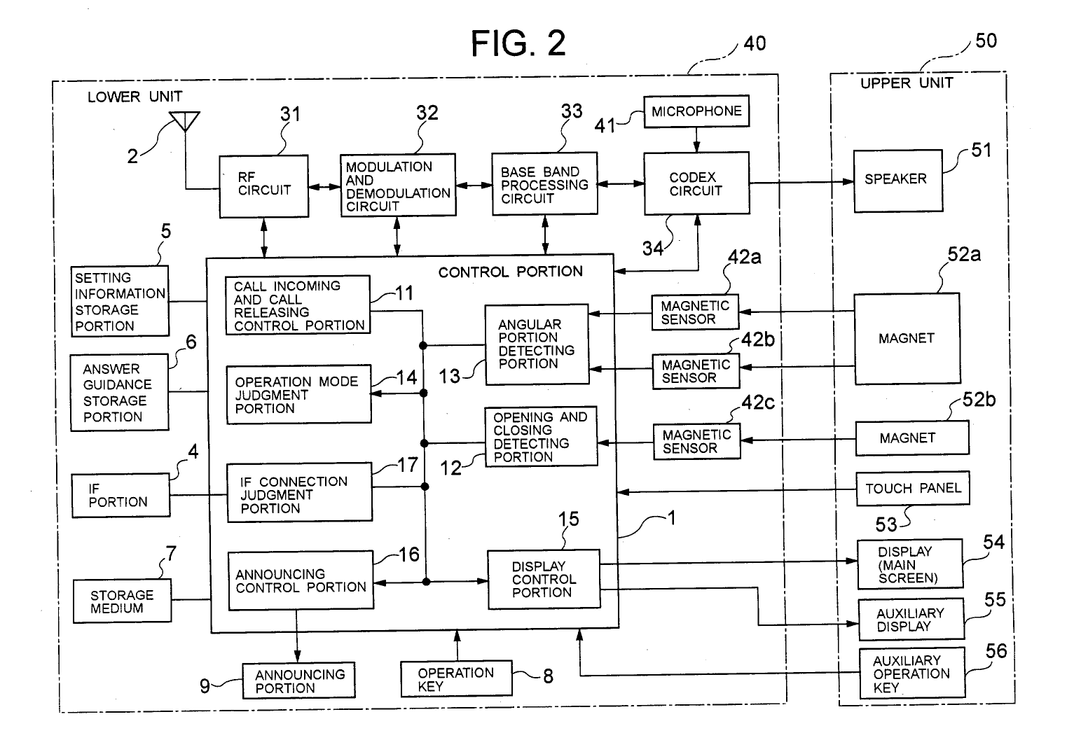

FIG. 2 is a block diagram showing a detailed construction of one embodiment of the portable information terminal according to the present invention. In FIG. 2, the portable information terminal includes the lower unit and the upper unit. The lower unit is identified by the reference numeral 40 and the upper unit is identified by the reference numeral 50. As set forth above, the lower unit 40 and the upper unit 50 are coupled for permitting opening and closing motion and pivoting motion.

In the lower unit 40, the antenna 2, an RF circuit 31, a modulation and demodulation circuit 32, abase band processing circuit 33, a codec circuit 34, the control portion 1, a microphone 41, three magnetic sensors 42a to 42c for detecting position of the upper unit 50 (attitude relative to the lower unit 40), the IF portion 4, the setting information storage portion 5, the answer guidance storage portion 6, the storage medium 7, an operation keys 8, and the announcing portion 9 are mounted. It should be noted that the RF circuit 31 includes not shown reception circuit, transmission circuit and frequency synthesizer.

On the other hand, in the upper unit 50, a speaker 51, a magnet 52a arranged corresponding to the magnetic sensors 42a and 42b, a magnet 52b corresponding to the magnetic sensor 42c, a display (liquid crystal display) 54 serving as primary display screen, a touch panel mechanism 53 incorporated on the surface of the display 54, an auxiliary display 55 and an auxiliary operation key 56 are provided. It should be noted that the speaker 51 functions as a telephone receiver and also serves as the announcing portion 9.

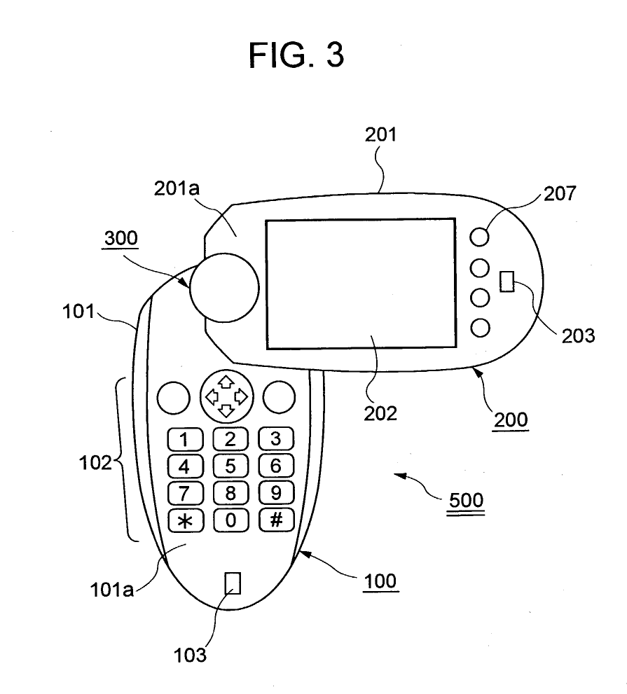

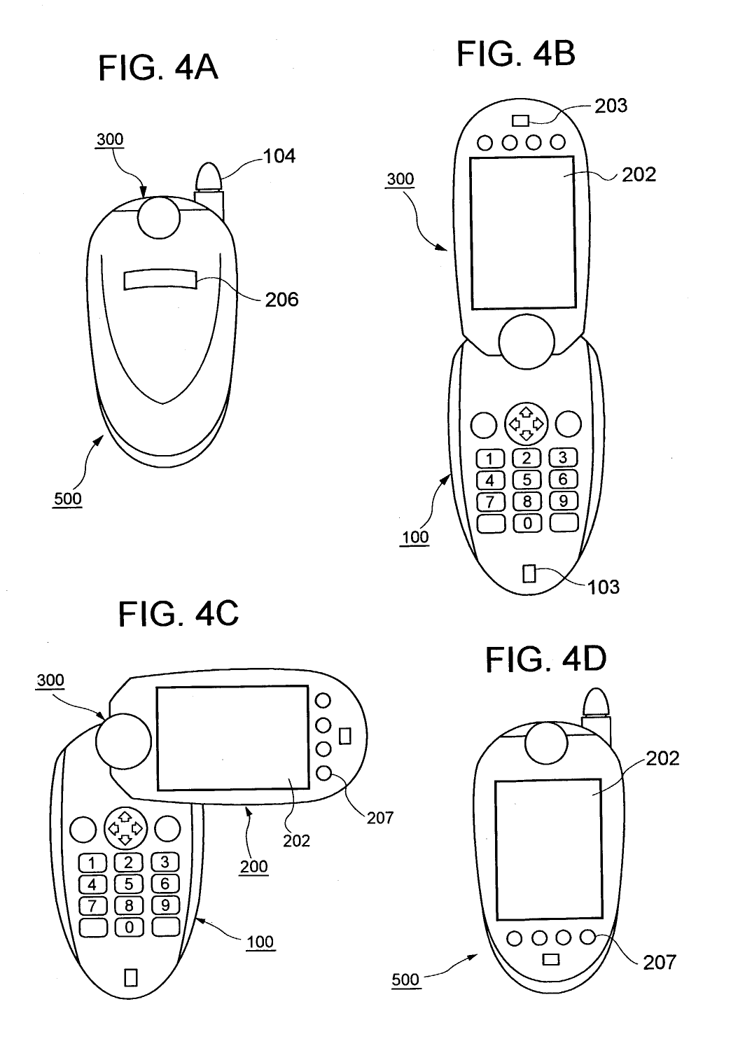

FIG. 3 is an external view of a cellular telephone unit applicable as one embodiment of the portable information terminal according to the invention. FIGS. 4A to 4D are illustration showing various pivoted condition of the portable information terminal shown in FIG. 3. FIG. 3 shows a condition where an upper unit 200 is reversed to direct a display surface 202 outward and is laterally pivoted to orient laterally.

In FIG. 3, the cellular telephone unit 500 is mainly constructed with a lower unit 100 having an operating portion and an upper unit 200 having a display portion 202, and a biaxial hinge 300 serving as a universal hinge or joint portion pivotably and rotatably coupling the lower unit 100 and the upper unit 200. The lower unit 100 corresponds to the lower unit 40 shown in FIG. 2, and the upper unit 200 corresponds to the upper unit 50 shown in FIG. 2.

The lower unit 100 and the upper unit 200 are essentially elliptic shape of substantially equal size, flat and predetermined thickness, and are mechanically coupled via the biaxial hinge 300. Thus, the upper unit 200 is pivotable and rotatable relative to the lower unit 100 about the biaxial hinge 300. On the other hand, the lower unit 100 and the upper unit 200 are electrically connected across the biaxial hinge 300 by means of an appropriate connection means (not shown).

Within an outer casing 101 of the lower unit 100, a construction of the lower unit 40 shown in FIG. 2 is housed or mounted. On one surface (operation surface) 101a of the lower unit 100, the operating portion formed with a plurality of operation keys 102 for using functions provided for the cellular telephone unit 500, is arranged. Furthermore, an opening portion of a microphone 103 is arranged at a tip end portion of the operation surface 101a.

On the other hand, in the vicinity of a base end portion of the operation surface 101a, a rotary shaft is rotatably secured at a substantially lateral center position distanced from an edge portion on the base end side of the lower unit 100 by a predetermined distance (substantially half of a thickness of the upper unit 200 and extended substantially perpendicular to the operation surface 101a with projecting a tip end thereof from the operation surface 101a.

Within an outer casing 201 of the upper unit 200, a construction of the upper unit 50 shown in FIG. 2 is housed or mounted. On one surface (display surface) 201a of the upper unit 200, a substantially rectangular display 202 is arranged in longitudinally elongated fashion in the normal state. On the other hand, a speaker 203 is arranged at a tip end portion. On the other hand, on a surface opposite to the display surface 201a, a small size auxiliary display 206 is provided.

As set forth above, the cellular telephone unit 500 is constructed by coupling the upper unit 200 and the lower unit 100 at respective base end portions by the biaxial hinge 300 which has two rotary shafts orthogonally intersecting for rotation independently with each other.

On the other hand, in the cellular telephone unit 500, the lower unit 100 and the upper unit 200 can take various relative positions (relative attitude). The relative position (relative attitude) of the lower unit 100 and the upper unit 200 can be detected by the magnetic sensors 42a to 42c and the magnets 52a and 52b cooperated with the magnetic sensors.

FIG. 4A is an external view showing the cellular telephone unit in folded condition orienting the display surface 201a of the upper unit 200 in opposition to the operating portion of the lower unit 100. This is the condition that the conventional cellular telephone unit is in folded condition to be compact for convenience in carrying. On the other hand, the display surface 201a is not externally exposed and thus protected. At this condition, minimum but satisfactory information is displayed on the auxiliary display 206.

FIG. 4B is an external view showing the cellular telephone unit in fully raised condition which is normal calling position. At this condition, similarly to the conventional cellular telephone, checking of display, various operations and calling can be performed.

FIG. 4C is an external view showing the cellular telephone unit in a condition where the upper unit 200 is pivoted about 90° in clockwise fashion along a plane parallel to the operating surface 101a of the lower unit 100 from the condition shown in FIG. 4B. Then, the display 202 is arranged in laterally elongated fashion. It should be noted that this condition is also established even by pivoting the upper unit 200 in counterclockwise direction from the folded condition shown in FIG. 4D.

On the other hand, while not illustrated, the upper unit 200 may be pivoted about 90° in counterclockwise direction along the plane parallel to the display plane from the normal calling position (normal raised position) shown in FIG. 4B. Even in this condition, the upper unit 200 is oriented substantially perpendicular to the lower unit 100 in substantially the same plane. The display 202 is oriented in laterally elongated fashion in relation to the longitudinal direction of the operating surface 110a.

Furthermore, upon closing the cellular telephone unit 500, it is possible to orient the upper unit 200 to externally expose the display 202 which is normally placed internally concealed position.

FIG. 4D is an external view of the cellular telephone unit 500 in the folded condition where the upper unit 200 is mated with the lower unit 100 in folded position as being oriented in reversed position directing the display surface 201a outwardly. For example, from the opened condition of the cellular telephone unit 200 as shown in FIG. 4B, the upper unit 200 is reversed to place the display surface 201a outward to and is placed in closed position relative to the lower unit 100 as shown in FIG. 4D. In this condition, the cellular telephone unit becomes compact for convenience in carrying and permits checking of the display content with maintaining folded condition. Also, in this condition, a second operating portion 207 is exposed externally, predetermined operation can be performed depending upon the display content using the second operating portion 207.

It is possible to detect the reversed condition of the upper unit 200 in folded condition shown in FIG. 4D by the angular position detecting portion 14, and to reverse the display content of the display 202 in up-side-down manner. At this time, among keys in the second operating portion 207, keys having directionality in process corresponding to the operation, such as direction key (cursor key) or the like, the process content may be adapted to the display direction. Thus, the display can be read as is and necessary operation can be performed with holding the cellular telephone unit 500 in hand in the same manner as the standard or normal folded condition.

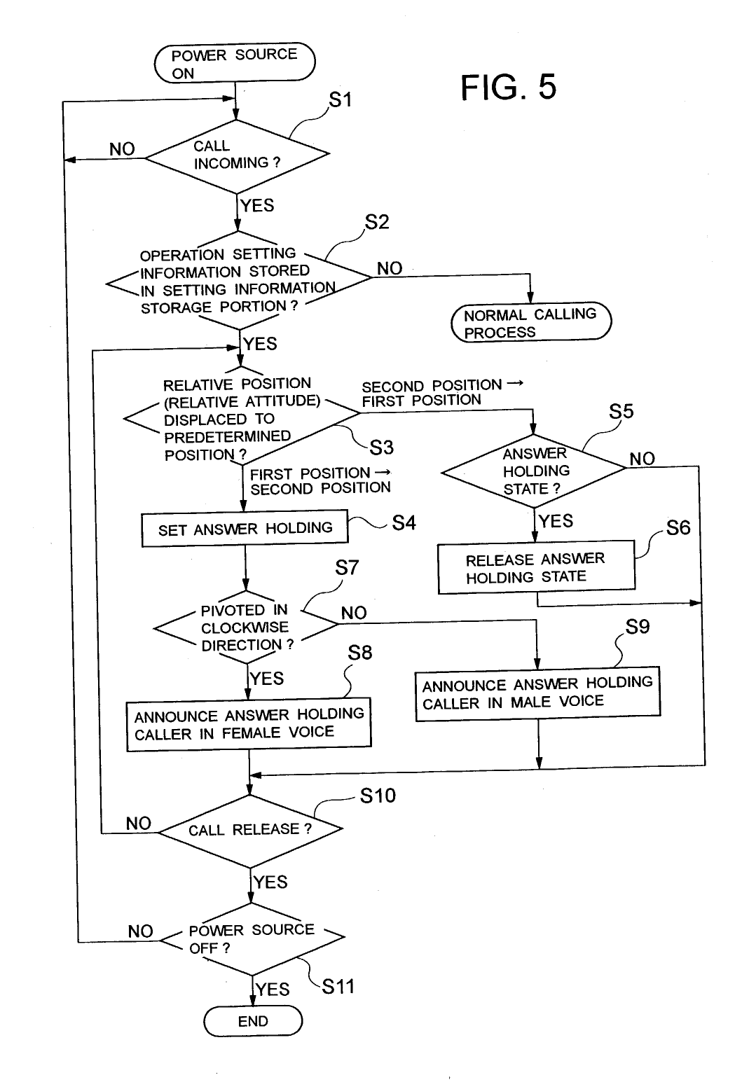

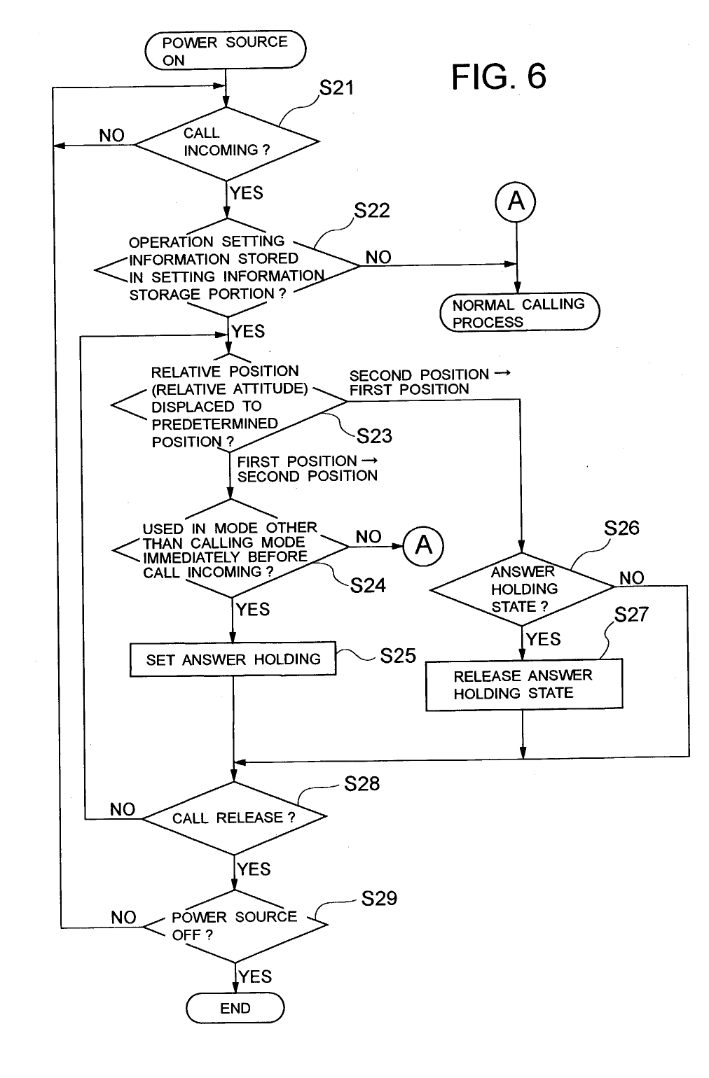

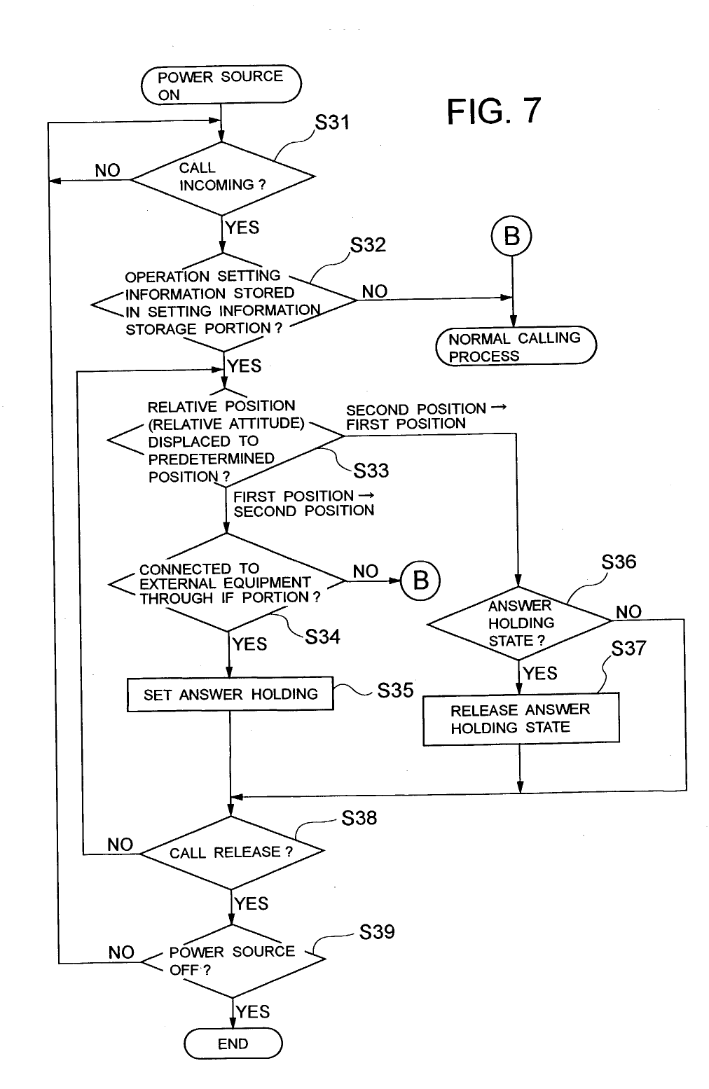

FIG. 5 is a flowchart showing one example of operation of the control portion 1 of FIG. 1, FIG. 6 is a flowchart showing example of another operation of the control portion of FIG. 1, and FIG. 7 is a flowchart showing example of another operation of the control portion of FIG. 1. Operation of one embodiment of the portable information terminal according to the present invention will be discussed in terms of a cellular telephone unit 500 with reference to FIGS. 1 to 7. The process operation shown in FIGS. 5 to 7 can be realized by executing the program stored in the storage medium 7 by the control portion 1.

In the cellular telephone unit 500, upon call incoming, change of relative position (relative attitude) of the lower unit 100 and the upper unit 200 is detected by the opening and closing detecting portion 12 or the angular position detecting portion 13 via the magnetic sensors 42a to 42c and the magnets 52a and 52b. Then, the cellular telephone unit 500 is set or released in or from the answer holding state.

Namely, through the operation keys 102 of the lower unit 100, an operation setting information for setting the cellular telephone unit in the answer holding state when the lower unit 100 and the upper unit 200 are placed at predetermined relative position (relative attitude) upon call incoming is preliminarily input. Then, the operation setting information thus input is stored in the setting information storage portion 5. For example, from the closed position as shown in FIG. 4A and 4D, as relative position between the lower unit 100 and the upper unit 200, if the upper unit 200 is pivoted to the position shown in FIG. 4C, the cellular telephone unit is placed in the answer holding state. Also, when information to make the operation setting information effective, is input from the operation keys 102, the input information is stored in the setting information storage portion 5.

Upon incoming of call (step S1 of FIG. 5), operation setting set forth above is done (step S2 of FIG. 5), and when the upper unit 200 is pivoted from the closed position shown in FIG. 4A or FIG. 4D (state placed at first position) to the position shown in FIG. 4C (second position) (step S3 of FIG. 5), the control portion 1 sets the cellular telephone unit in the answer holding state (step S4 of FIG. 5).

On the other hand, when the upper unit 200 is further pivoted from the pivoted position of the upper unit 200 relative to the lower unit 100 as shown in FIG. 4C or the like to the position as shown in Fig.4B, and when the cellular telephone unit is set in answer holding state, operating setting information for placing the cellular telephone unit in answer holding released state and information for making the operation setting information effective are input from the operation keys 102, the input information is stored in the setting information storage portion 5.

In this case, upon incoming of call (step S1 of FIG. 5), operation setting is done (step S2 of FIG. 5), the upper unit 200 is pivoted from the position shown in FIG. 4C (state placed at the second position) to the position shown in FIG. 4B (second position) (step S3 of FIG. 5). If the current state of the cellular telephone unit is set in answer holding state (step S5 of FIG. 5), the control portion 1 releases the answer holding state (step S6 of FIG. 5).

On the other hand, when a plurality of answer holding guidance messages are stored in the answer guidance storage portion 6 as answer guidance message to be notified the foregoing answer holding state to the caller, the control portion 1 performs the following operation. When the upper unit 200 is placed at the closed position shown in FIG. 4A or 4D and is pivoted to the position shown in FIG. 4C (pivoted in counterclockwise direction)(step S7 of FIG. 5), the control portion 1 announces the answer holding state by male voice (step S9 of FIG. 5). On the other hand, when the upper unit 200 is pivoted in clockwise direction (step S7 of FIG. 5), the answer holding state is announced by female voice (step S8 of FIG. 5).

If call with the caller is not through (step S10 of FIG. 5), the control portion 1 continues the process returning to step S3. When call with the caller is through (step S10 of FIG. 5), the foregoing process operation is repeated until the power source of the own terminal is turned OFF. It should be noted that the control portion 1 may control to output arbitrary message depending upon relative position of the lower unit 100 and the upper unit 200, and so forth.

In the cellular telephone unit 500, operation setting information for setting the cellular telephone unit in answer holding state upon incoming of call, if the upper unit 200 is pivoted from the closed position shown in FIG. 4A or 4D (state placed at the first position) to the position shown in FIG. 4C (second position), the cellular telephone unit is used in a mode other than calling mode, such as gaming, reproducing content, sending, receiving or reading electronic mail, accessing website and so forth, up to a timing immediately before call incoming, and the information for making the operation setting information effective, are input from the operation keys 102, the input information is stored in the setting information storage portion 5.

In this case, upon call incoming (step S21 of FIG. 6), when operation setting is performed (step S22 of FIG. 6), the upper unit 200 is pivoted or displaced from the closed position shown in FIG. 4A or 4D (state placed at the first position) to the position shown in FIG. 4C (second position) (step S23 of FIG. 6), and the cellular telephone unit is used in the operation mode other than calling mode up to a timing immediately before call incoming (step S24 of FIG. 6), the control portion 1 sets answer holding state (step S25 of FIG. 6).

On the other hand, when the upper unit 200 is pivoted from the position shown in FIG. 4C to the position shown in FIG. 4D and if the operation setting information for releasing answer holding state when the answer holding state is set and information to make the operation setting information effective are input through the operation key 102, the input information is stored in the setting information storage portion 5.

In this case, upon call incoming (step S21 of FIG. 6), when operation setting is performed (step S22 of FIG. 6), the upper unit 200 is pivoted or displaced from the position shown in FIG. 4C (state placed at the second position) to the position shown in FIG. 4B (second position) (step S23 of FIG. 6), and answer holding state is set (step S26 of FIG. 6), the control portion 1 releases answer holding state (step S27 of FIG. 6).

If call with the caller is not through (step S28 of FIG. 6), the control portion 1 continues the process returning to step S23. On the other hand, when call with the caller is through (step S28) of FIG. 6), the foregoing process operation is repeated until the power source of the own terminal is turned OFF (step S29 of FIG. 6).

In the cellular telephone unit 500, operation-setting information for setting the cellular telephone unit in answer holding state upon incoming of call, if the IF portion 4 for connection with the external equipment is provided, the upper unit 200 is pivoted from the closed position shown in FIG. 4A or 4D (state placed at the first position) to the position shown in FIG. 4C (second position), and the control portion 1 detects connection with the external equipment via the IF portion 4, and the information for making the operation setting information effective, are input from the operation keys 102, the input information is stored in the setting information storage portion 5.

In this case, upon call incoming (step S31 of FIG. 7), when operation setting is performed (step S32 of FIG. 7), the upper unit 200 is pivoted or displaced from the closed position shown in FIG. 4A or 4D (state placed at the first position) to the position shown in FIG. 4C (second position) (step S33 of FIG. 7), and connection with the external equipment via the IF portion 4 is detected (step S34 of FIG. 7), the control portion 1 sets answer holding state (step S35 of FIG. 7).

On the other hand, when the upper unit 200 is further pivoted from the position shown in FIG. 4C to the position shown in FIG. 4B and if the operation setting information for releasing answer holding state when the answer holding state is set and information to make the operation setting information effective are input through the operation key 102, the input information is stored in the setting information storage portion 5.

In this case, upon call incoming (step S31 of FIG. 7), when operation setting is performed (step S32 of FIG. 7), the upper unit 200 is pivoted or displaced from the closed position shown in FIG. 4C (state placed at the second position) to the position shown in FIG. 4B (second position) (step S33 of FIG. 7), and answer holding state is set (step S36 of FIG. 7), the control portion 1 releases answer holding state (step S37 of FIG. 7).

If call with the caller is not through (step S38 of FIG. 7), the control portion 1 continues the process returning to step S33. On the other hand, when call with the caller is through (step S38 of FIG. 7), the foregoing process operation is repeated until the power source of the own terminal is turned OFF (step S39 of FIG. 7).

As set forth above, in the embodiments set forth above, upon call incoming, the lower unit 100 and the upper unit 200 are open and closed and pivoted for setting and releasing answer holding. Thus, setting and releasing of answer holding can be set by simple operation.

On the other hand, in the shown embodiments, since setting can be made depending upon operation mode immediately before call incoming and presence and absence of connection with the external equipment, control upon call incoming can be performed in consideration of the operation of the cellular telephone unit at a timing immediately before call incoming so as to avoid the user from hurrying to respond.

Furthermore, in the shown embodiments, since a plurality of answer holding guidance messages stored in the answer holding guidance storage portion 6 can be selectively announced by detecting opening and closing and pivoting operation of the lower unit 100 and the upper unit 200, a plurality of guidance messages can be selectively used by simple operation.

It should be noted that the shown embodiment has been discussed in terms of the cellular telephone unit 500, it is also possible to apply the present invention even for other portable terminal, such as PDA (personal digital assistant) and so on. On the other hand, while the shown embodiment has been discussed to independently perform process operation shown in FIGS. 5 to 7, it is possible to perform operation by combining these processes.

As set forth above, according to the present invention, in the foldable type portable information terminal, in which the upper unit having the display screen in either of the upper or lower surfaces and the lower unit having the operation surface in either upper or lower surfaces are coupled for opening and closing and for pivoting, upon call incoming, upon detecting change of relative attitude between the upper unit and the lower unit, and upon detection of the upper unit at preliminarily set at predetermined position, answer holding state is set to permit setting and releasing of the terminal by simple operation.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A foldable type portable information terminal comprising:
an upper unit having a display screen on one of upper and lower surfaces;
a lower unit having an operation surface on one of upper and lower surfaces, and coupled with said upper unit for opening and closing and for pivoting;
detecting means for detecting change of relative attitude between said upper unit and said lower unit; and
control means for setting answer holding state when said detecting means detects displacement of said upper unit to a preliminarily set first position upon call incoming.

2. A foldable type portable information terminal as set forth in claim 1, wherein said control means releases answer holding state which is set previously, when said detecting means detects displacement of said upper unit to a preliminarily set second position.

3. A foldable type portable information terminal as set forth in claim 1, which further comprises interfacing means for connection with an external equipment,
said control means sets answer holding state when said detecting means detects displacement of said upper unit to said first position and further detects connection with said external equipment.

4. A foldable type portable information terminal as set forth in claim 1, wherein said control means performs control for outputting answer holding guidance depending upon displacement position of said upper unit when said detecting means detects displacement of one of a plurality of preliminarily set positions upon call incoming.

5. A foldable type portable information terminal as set forth in claim 1, wherein said control means sets answer holding state when said upper unit is displaced to another preliminarily set position only when said upper unit is in a preliminarily set position, upon call incoming.

6. A foldable type portable information terminal as set forth in claim 1, wherein said control means sets answer holding state when said upper unit is displaced to another preliminarily set position only when said upper unit is in a preliminarily set position and said portable information terminal is in a predetermined operation mode, upon call incoming.

7. An answer holding method of a foldable type portable information terminal including an upper unit having a display screen on one of upper and lower surfaces, and a lower unit having an operation surface on one of upper and lower surfaces, and coupled with said upper unit for opening and closing and for pivoting, comprising:
detecting step of detecting change of relative attitude between said upper unit and said lower unit; and
control step of setting answer holding state when displacement of said upper unit to a preliminarily set first position is detected upon call incoming.

8. An answer holding method as set forth in claim 7, which further comprises step of releasing answer holding state which is set previously, when displacement of said upper unit to a preliminarily set second position is detected.

9. An answer holding method as set forth in claim 7, wherein said step of setting answer holding state sets answer holding state when displacement of said upper unit to said first position is detected and connection with said external equipment is detected.

10. An answer holding method as set forth in claim 7, which further comprises step of outputting answer holding guidance depending upon displacement position of said upper unit when displacement of one of a plurality of preliminarily set positions is detected upon call incoming.

11. An answer holding method as set forth in claim 7, wherein said step of setting answer holding state sets answer holding state when said upper unit is displaced to another preliminarily set position only when said upper unit is in a preliminarily set position, upon call incoming.

12. An answer holding method as set forth in claim 7, wherein said step of answer holding state sets answer holding state when said upper unit is displaced to another preliminarily set position only when said upper unit is in a preliminarily set position and said portable information terminal is in a predetermined operation mode, upon call incoming.

13. A program of an answer holding method of a foldable type portable information terminal including an upper unit having a display screen on one of upper and lower surfaces, and a lower unit having an operation surface on one of upper and lower surfaces, and coupled with said upper unit for opening and closing and for pivoting, comprising:
detecting step of detecting change of relative attitude between said upper unit and said lower unit; and
control step of setting answer holding state when displacement of said upper unit to a preliminarily set first position is detected upon call incoming.

14. A foldable type cellular telephone unit comprising:
an upper unit having a display screen on one of upper and lower surfaces;
a lower unit having an operation surface on one of upper and lower surfaces, and coupled with said upper unit for opening and closing and for pivoting;
detecting means for detecting change of relative attitude between said upper unit and said lower unit; and
control means for setting answer holding state when said detecting means detects displacement of said upper unit to a preliminarily set first position upon call incoming.

15. An answer holding method of a foldable type cellular telephone unit including an upper unit having a display screen on one of upper and lower surfaces, and a lower unit having an operation surface on one of upper and lower surfaces, and. coupled with said upper unit for opening and closing and for pivoting, comprising:
detecting step of detecting change of relative attitude between said upper unit and said lower unit; and
control step of setting answer holding state when displacement of said upper unit to a preliminarily set first position is detected upon call incoming.
